(19) United States
(12) Patent Application Publication
(10) Pub. No.: US 2019/0147267 A1
(43) Pub. Date: May 16, 2019

(54) DISTRACTED DRIVING DETERMINATION APPARATUS, DISTRACTED DRIVING DETERMINATION METHOD, AND PROGRAM FOR DISTRACTED DRIVING DETERMINATION

(71) Applicant: OMRON Corporation, Kyoto-shi (JP)

(72) Inventors: Tomoyoshi AIZAWA, Kyoto-shi (JP); Tadashi HYUGA, Hirakata-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/143,456

(22) Filed: Sep. 27, 2018

(30) Foreign Application Priority Data
Nov. 15, 2017 (JP) 2017-220009

(51) Int. Cl. G06K 9/00; G06T 7/73; G01P 15/14; B62D 15/02; B60K 35/00; B60W 50/14

(52) U.S. Cl. CPC G06K 9/00845; G06T 7/75; G01P 15/14; B62D 15/0245; B60W 2050/143; B60W 50/14; G06T 2207/10021; G06T 2207/30201; B60W 2050/146; B60K 35/00

(57) ABSTRACT

Distracted driving determination reflects changes in the traveling direction of the vehicle. A distracted driving determination apparatus includes a first obtaining unit obtaining first detection information indicating a gaze or face orientation of a driver, a determiner determining whether the driver is engaging in distracted driving based on the gaze or face orientation of the driver indicated by the first detection information and a first determination condition for detecting distracted driving, a second obtaining unit obtaining second detection information indicating a rotational angle velocity about a vertical axis or lateral acceleration of a vehicle, and a condition changer changing the first determination condition to a second determination condition different from the first determination condition to use the second determination condition in the duration for which the rotational angle velocity or the lateral acceleration failing to satisfy a predefined criterion is being detected based on the second detection information.

### CROSS-REFERENCE TO RELATED APPLICATION

This application claims priority to Japanese Patent Application No. 2017-220009 filed on Nov. 15, 2017, the entire disclosure of which is incorporated herein by reference.

### FIELD

The present invention relates to a distracted driving determination apparatus that determines distracted driving of a vehicle driver, a distracted driving determination method, and a program for distracted driving determination.

### BACKGROUND

Techniques have been developed to determine distracted driving of a driver by capturing an image of the face of the driver and determining his or her face orientation with an image processor, as one such example is described in Patent Literature 1. The technique described in Patent Literature 1 changes the detection sensitivity of distracted driving depending on the vehicle state.

### CITATION LIST

### Patent Literature

Patent Literature 1: Japanese Unexamined Patent Application Publication No. 2001-138767

### SUMMARY

### Technical Problem

The direction of the driver's intended gaze changes typically depending on the vehicle state. The action of the driver looking in a specific direction can be distracted driving in one vehicle state, or may not be distracted driving and may rather be an intended gaze in another vehicle state.

However, the technique described in Patent Literature 1 does not reflect changes in the traveling direction of the vehicle intended by the driver, such as right or left turns and lane changes. The checking action of the driver during such intended changes in the vehicle traveling direction may be determined to be distracted driving.

In response to the above issue, one or more aspects of the present invention are directed to a technique for determining distracted driving while reflecting changes in the traveling direction of the vehicle.

### Solution to Problem

A distracted driving determination apparatus according to a first aspect of the disclosure includes a first obtaining unit that obtains first detection information indicating a gaze or a face orientation of a driver, a determiner that determines whether the driver is engaging in distracted driving based on the gaze or the face orientation of the driver indicated by the first detection information and a first determination condition defined for detecting distracted driving, a second obtaining unit that obtains second detection information indicating a rotational angle velocity about a vertical axis or lateral acceleration of a vehicle, and a condition changer that changes the first determination condition to a second determination condition different from the first determination condition to use the second determination condition in a duration for which the rotational angle velocity or the lateral acceleration failing to satisfy a predefined criterion is being detected based on the second detection information.

The distracted driving determination apparatus according to the first aspect determines distracted driving based on the gaze or the face orientation of the driver and the first determination condition in the duration for which the rotational angle velocity or the lateral acceleration failing to satisfy the predefined criterion is not being detected during traveling of the vehicle, and determines distracted driving based on the gaze or the face orientation of the driver and the second determination condition, which differs from the first determination condition, in the duration for which the rotational angle velocity or the lateral acceleration failing to satisfy the predefined criterion is being detected. The state in which the rotational angle velocity or the lateral acceleration failing to satisfy the predefined criterion is being detected equates to the state in which the vehicle is determined to be changing its traveling direction rightward or leftward. The distracted driving determination apparatus with the above structure thus enables distracted driving determination performed while reflecting changes in the traveling direction of the vehicle.

A distracted driving determination apparatus according to a second aspect of the disclosure is the distracted driving determination apparatus according to the first aspect in which the condition changer changes a left determination condition included in the first determination condition and defined for detecting distracted driving for a left of the vehicle to a left determination condition included in the second determination condition to use the left determination condition in a duration for which the rotational angle velocity associated with left turning of the vehicle or the lateral acceleration associated with a first direction from left to right of the vehicle failing to satisfy a predefined first criterion is being detected. The condition changer changes a right determination condition included in the first determination condition and defined for detecting distracted driving for a right of the vehicle to a right determination condition included in the second determination condition to use the right determination condition in a duration for which the rotational angle velocity associated with right turning of the vehicle or the lateral acceleration associated with a second direction from right to left of the vehicle failing to satisfy a predefined second criterion is being detected.

The distracted driving determination apparatus according to the second aspect determines distracted driving using the left determination condition when the vehicle is traveling leftward, and determines distracted driving using the right determination condition when the vehicle is traveling rightward. This structure enables distracted driving determination using determination conditions appropriately defined for left turning and right turning.

A distracted driving determination apparatus according to a third aspect of the disclosure is the distracted driving determination apparatus according to the first or second aspect in which the condition changer changes the first determination condition to the second determination condition to enlarge an area in which the gaze or the face orientation of the driver is allowed to reside without detection of distracted driving.

The distracted driving determination apparatus according to the third aspect enlarges the area in which the gaze or the face orientation of the driver is allowed to reside without detection of distracted driving in the duration for which the rotational angle velocity or the lateral acceleration failing to satisfy the predefined criterion is being detected during traveling of the vehicle. This structure may lower the likelihood that distracted driving is detected when the driver directs his or her gaze or face rightward or leftward for safety checking to, for example, turn right, turn left, change the lane to the right or left, or change the traveling direction leftward to pull over to the side of a road in the duration for which the rotational angle velocity or the lateral acceleration is being detected.

A distracted driving determination apparatus according to a fourth aspect of the disclosure is the distracted driving determination apparatus according any one of the first to third aspects in which the determiner determines that the driver is not engaging in distracted driving when the gaze or the face orientation of the driver is within a first area defined in front of the driver. The determiner determines that the driver is engaging in distracted driving when the gaze or the face orientation of the driver resides within a second area defined on the left of the vehicle and adjacent to the first area for longer than a first duration, or within a third area defined on the right of the vehicle and adjacent to the first area for longer than a second duration.

The distracted driving determination apparatus according to the fourth aspect determines that the driver is engaging in distracted driving when the gaze or face orientation of the driver resides within the second area defined on the left of the vehicle for more than the first duration. The distracted driving determination apparatus determines that the driver is engaging in distracted driving when the gaze or face orientation of the driver resides within the third area defined on the right of the vehicle longer than the second duration. This enables distracted driving determination using different determination conditions for the right and left of the vehicle.

A distracted driving determination apparatus according to a fifth aspect of the disclosure is the distracted driving determination apparatus according the fourth aspect in which the condition changer performs, in response to detection of the rotational angle velocity associated with left turning or the lateral acceleration associated with the first direction failing to satisfy the first criterion, a first change process at least by shifting a boundary between the first and second areas from a position used when the rotational angle velocity or the lateral acceleration satisfies the criterion to a position to enlarge the first area, or by extending the first duration. The condition changer performs, in response to detection of the rotational angle velocity associated with right turning or the lateral acceleration associated with the second direction failing to satisfy the second criterion, a second change process at least by shifting a boundary between the first and third areas from a position used when the rotational angle velocity or the lateral acceleration satisfies the criterion to a position to enlarge the first area, or by extending the second duration.

The distracted driving determination apparatus according to the fifth aspect enlarges the first area defined in front of the vehicle and reduces the second area defined on the left of the vehicle, or extends the first duration for which the gaze or face orientation is allowed to reside within the second area when the vehicle is turning left. Similarly, the distracted driving determination apparatus enlarges the first area and reduces the third area defined on the right of the vehicle, or extends the second duration for which the gaze or face orientation is allowed to reside within the third area when the vehicle is turning right.

This structure lowers the likelihood that distracted driving is detected when the driver directs his or her gaze or face rightward or leftward when the vehicle is traveling rightward or leftward. This structure thus reduces erroneous determination in which the checking action of the driver to the right or left to, for example, turn right, turn left, change the lane, or pull over to the side of a road is determined to be distracted driving.

A distracted driving determination apparatus according to a sixth aspect of the disclosure further includes an output unit that outputs an instruction signal to a support apparatus to support the driver when the determiner determines that the driver is engaging in distracted driving.

The distracted driving determination apparatus according to the sixth aspect outputs the instruction signal to the support apparatus to support the driver when the driver is determined to be engaging in distracted driving. This structure allows the driver to receive driving support from the support apparatus, thus effectively reducing distracted driving.

### Advantageous Effects

One or more aspects of the present invention provide a technique enabling distracted driving determination reflecting changes in the traveling direction of the vehicle.

### BRIEF DESCRIPTION OF THE DRAWINGS

FIG. 1 is a schematic diagram describing an example use of a distracted driving determination apparatus according to an embodiment.

FIG. 2 is a schematic diagram of a vehicle including the distracted driving determination apparatus according to the present embodiment showing its overall structure.

FIG. 3 is a block diagram of the distracted driving determination apparatus according to the present embodiment showing its hardware configuration.

FIG. 4 is a schematic diagram describing a usual driving determination condition.

FIG. 5 is a block diagram of the distracted driving determination apparatus according to the present embodiment showing its software configuration.

FIG. 6 is a schematic diagram describing a left determination condition.

FIG. 7 is a schematic diagram describing a right determination condition.

FIG. 8 is a flowchart showing distracted driving determination performed by the distracted driving determination apparatus according to the present embodiment.

FIG. 9 is a flowchart showing an example operation for relaxing a determination condition performed by the distracted driving determination apparatus according to the present embodiment.

### DETAILED DESCRIPTION

An embodiment of the present disclosure (hereafter, the present embodiment) will now be described with reference to the drawings. The present embodiment described below is a mere example in any aspect. The same or similar components as already described are given the same or similar reference numerals, and will not be described repeatedly. Although data used in the present embodiment is described in a natural language, such data may be specifically defined using a pseudo language, a command, a parameter, or a machine language.

### 1. EXAMPLE USE

A distracted driving determination apparatus according to the present embodiment determines whether the driver is engaging in distracted driving based on a gaze or face orientation of the driver and a first determination condition for determining distracted driving. The distracted driving determination apparatus obtains detection information indicating the rotational angle velocity about the vertical axis or lateral acceleration of the vehicle. The distracted driving determination apparatus changes the first determination condition to a second determination condition different from the first determination condition when the rotational angle velocity or the lateral acceleration fails to satisfy a predefined criterion.

The first and the second determination conditions are, for example, a duration for which the gaze or face orientation of the driver is allowed to reside (to be retained) within at least one of multiple imaginary areas defined around the driver. The imaginary areas may include, for example, an area defined to range leftward or an area defined to range rightward. The second determination condition is set to a value with which distracted driving is less likely to be detected based on the gaze or face orientation of the driver directed rightward or leftward when the rotational angle velocity (yaw rate) about the vertical axis of the vehicle or lateral acceleration of the vehicle fails to satisfy a predefined criterion than when the criterion is satisfied. In other words, the second determination condition allows more distracted driving.

The criterion is set to a value that prevents the vehicle swinging right and left while driving or traveling along a curved road from being determined to be changing the traveling direction rightward or leftward to, for example, turn right, turn left, change the lane, or pull over to the side of a road based on the rotational angle velocity or lateral acceleration of the vehicle.

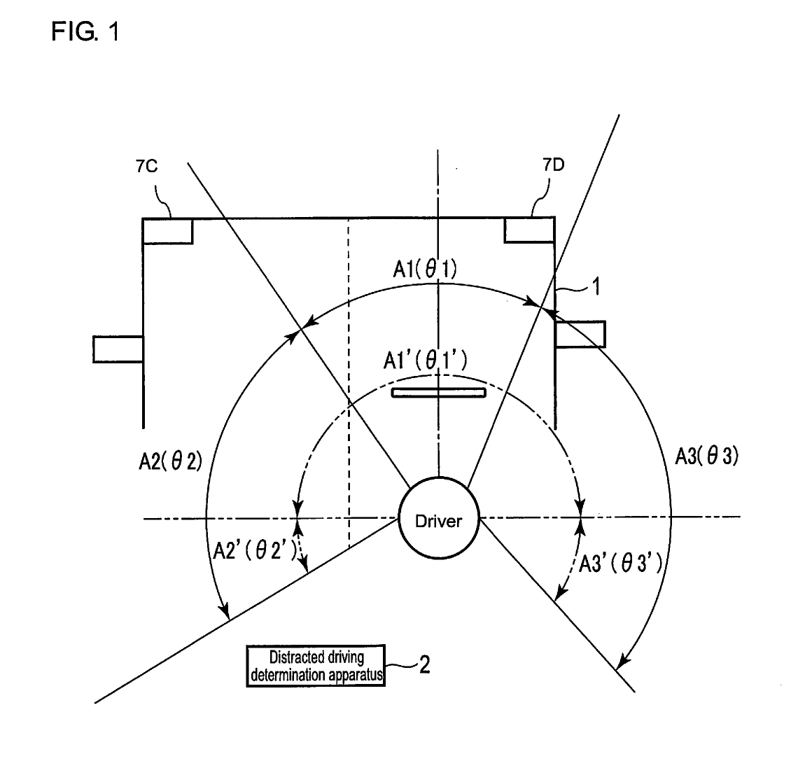

FIG. 1 is a schematic diagram describing an example use of a distracted driving determination apparatus 2, which is mounted on a vehicle 1. FIG. 1 shows the vehicle 1 viewed from above. The radial solid lines indicate imaginary areas A1, A2, and A3 defined when the vehicle 1 is traveling straight along a road. The two-dot chain lines indicate imaginary areas A1′, A2′, and A3′ defined when the vehicle 1 is changing the traveling direction rightward or leftward. The broken line indicates the centerline in the width direction of the vehicle 1, and the dot-and-dash line indicates the straight traveling direction of the vehicle 1. Although FIG. 1 shows the vehicle with a right-hand steering wheel, the present embodiment is applicable to a vehicle with a left-hand steering wheel.

The first area. A1 is an imaginary area horizontally ranging from the driver toward the front of the vehicle 1 at a first angle θ1. The first area A1 is defined as an area in which the driver is determined not to be engaging in distracted driving. The second area A2 is an imaginary area adjacent to the first area A1 and horizontally ranging from the driver toward the left of the vehicle 1 at a second angle θ2. The second area A2 is associated with a first duration for which the gaze or face orientation of the driver is allowed to be retained. The third area A3 is an imaginary area adjacent to the first area A1 and horizontally ranging from the driver toward the right of the vehicle 1 at a third angle θ3. The third area A3 is associated with a second duration for which the gaze or face orientation of the driver is allowed to be retained.

The retention of the gaze or face orientation refers to the gaze or face orientation residing continuously within a predetermined area. This equates to detecting the gaze or face orientation directed continuously in one of the above areas for a predetermined duration, or detecting the gaze or face orientation residing continuously within a predetermined area for a predetermined duration.

The distracted driving determination apparatus 2 obtains detection information indicating the rotational angle velocity about the vertical axis of the vehicle 1 or lateral acceleration of the vehicle 1 changing the traveling direction rightward or leftward. Based on the detection information, the distracted driving determination apparatus 2 determines whether the rotational angle velocity (yaw rate) about the vertical axis of the vehicle 1 or the lateral acceleration of the vehicle 1 satisfies a predefined criterion. As described above, the criterion is set to a value to prevent the vehicle 1 swinging right and left while driving or traveling along a curved road from being determined to be changing the traveling direction rightward or leftward to, for example, turn right, turn left, change the lane, or pull over to the side of a road based on the rotational angle velocity or lateral acceleration of the vehicle 1.

Based on the detection result indicating the rotational angle velocity (yaw rate) about the vertical axis of the vehicle 1 or the lateral acceleration of the vehicle 1, the distracted driving determination apparatus 2 may determine that the vehicle 1 is traveling straight. In this case, the distracted driving determination apparatus 2 sets the first area A1 to the first angle θ1, the second area A2 to the second angle θ2, and the third area A3 to the third angle θ3 into a distracted driving determination condition. This is referred to as a first determination condition.

Based on the detection result indicating the rotational angle velocity (yaw rate) of the vehicle 1 or the lateral acceleration of the vehicle 1, the distracted driving determination apparatus 2 may determine that the vehicle 1 is traveling rightward or leftward. In this case, the distracted driving determination apparatus 2 changes the angle of the first area A1 to the angle θ1′ larger than the first angle θ1, the angle of the second area A2 to the angle θ2′ smaller than the second angle θ2, and the angle of the third area A3 to the angle θ3′ smaller than the third angle θ3 as shown in FIG. 1. More specifically, the first area A1 is enlarged, whereas the second area A2 and the third area A3 are reduced. This is referred to as a second determination condition. The angles θ1, θ2, and θ3 are changed to the angles θ1′, θ2′, and θ3′ by, for example, shifting the boundary between the first area A1 and the second area A2, and the boundary between the first area A1 and the third area A3.

The first, the second, and the third areas are each defined by the angles with respect to the driver as the center. In some embodiments, the first, the second, and the third areas may be defined as the dimensions of a rectangular or ellipsoidal area ranging frontward, rightward, and leftward of the vehicle 1 (e.g., the length of the area parallel to the front face or the side of the vehicle 1).

The distracted driving determination apparatus 2 obtains detection information indicating the gaze or face orientation of the driver from a gaze detector (not shown). Based on the detection information, the distracted driving determination apparatus 2 determines distracted driving by determining one of the areas A1, A2, and A3 or one of the areas A1′, A2′, or A3′ in which the gaze or face orientation of the driver is retained.

When, for example, the gaze or face orientation of the driver is within the first area A1 or A1′, the distracted driving determination apparatus 2 determines that the driver is not engaging in distracted driving irrespective of the retention allowable duration. When the gaze or face orientation of the driver is retained continuously within the second area A2 or A2′ for more than the first duration, the distracted driving determination apparatus 2 determines that the driver is engaging in distracted driving. Similarly, when the gaze or face orientation of the driver is continuously within the third area A3 or A3′ for more than the second duration, the distracted driving determination apparatus 2 determines that the driver is engaging in distracted driving.

For this structure, the first determination condition is first set as the condition for determining distracted driving when the vehicle 1 is traveling straight. Under this condition, once the gaze or face orientation of the driver is continuously within the second area A2 for more than the first duration or is continuously within the third area A3 for more than the second duration, the distracted driving determination apparatus 2 determines that the driver is engaging in distracted driving.

When the vehicle 1 changes the traveling direction rightward or leftward to turn right or left, for example, such a change is detected based on the detection result indicating the rotational angle velocity (yaw rate) about the vertical axis of the vehicle 1 or the lateral acceleration of the vehicle 1. In this case, the distracted driving determination condition is changed from the first determination condition to the second determination condition. When, for example, the vehicle is turning left, the driver may direct his or her gaze or face leftward, and the retention allowable duration may exceed the first duration. However, the distracted driving determination apparatus 2 determines that the driver is not engaging in distracted driving when the gaze or face orientation is within the first area A1′ set after the change. Similarly, when, for example, the vehicle is turning right, the driver may gaze and direct his or her face rightward, and the retention allowable duration may exceed the second duration. However, the distracted driving determination apparatus 2 determines that the driver is not engaging in distracted driving when the gaze or face orientation is within the first area A1′ set after the change.

When the vehicle 1 is determined to be traveling rightward or leftward based on the detection result indicating the rotational angle velocity (yaw rate) about the vertical axis of the vehicle 1 or the lateral acceleration of the vehicle 1, distracted driving is less likely to be detected than when the vehicle 1 is determined to be travelling straight. This structure thus reduces erroneous determination in which the action of safety checking performed by the driver to the right or left to, for example, turn right, turn left, change the lane, or pull over to the side of a road is determined to be distracted driving.

In turning right or left, however, the distracted driving determination apparatus 2 may determine that the driver is engaging in distracted driving when, for example, the gaze or the face of the driver is directed greatly rightward or leftward to the rear of the vehicle and retained within the second area A2′ for more than the first duration or within the third area A3′ for more than the second duration set after the change. The distracted driving determination apparatus 2 may thus determine that the driver is engaging in distracted driving when the driver changes his or her gaze or face orientation greatly.

In other words, the distracted driving determination apparatus according to the present embodiment achieves a distracted driving determination range reflecting the traveling direction of the vehicle.

Although the distracted driving determination process is performed for both the right and the left in the present embodiment, the process may be performed for either direction.

In the present embodiment, the first determination condition is defined by the angles θ1, θ2, and θ3 of the first, second, and third areas A1, A2, and A3 when the vehicle 1 is determined to be traveling straight. The second determination condition is defined by the angles θ1′ θ2′, and θ3′ of the first, second, and third areas A1, A2, and A3 when the vehicle 1 is determined to be changing the traveling direction rightward or leftward.

The above embodiment is not restrictive. The angles θ1, θ2, and θ3 of the first, second, and third areas may not be changed, but the first duration or the second duration, which indicates the retention allowable duration for the gaze and face orientation may be changed for the second area A2 and the third area A3. When, for example, the vehicle 1 is determined to be traveling rightward or leftward, the first duration for the second area A2 and the second duration for the third area A3 are set longer than when the vehicle 1 is determined to be travelling straight.

This structure detects distracted driving with a lower likelihood when the vehicle 1 is traveling rightward or leftward than when the vehicle 1 is travelling straight. This structure thus reduces erroneous determination in which the action of safety checking performed by the driver to the right or left to, for example, turn right, turn left, change the lane, or pull over to the side of a road is determined to be distracted driving.

### 2. EXAMPLE CONFIGURATION

### Vehicle

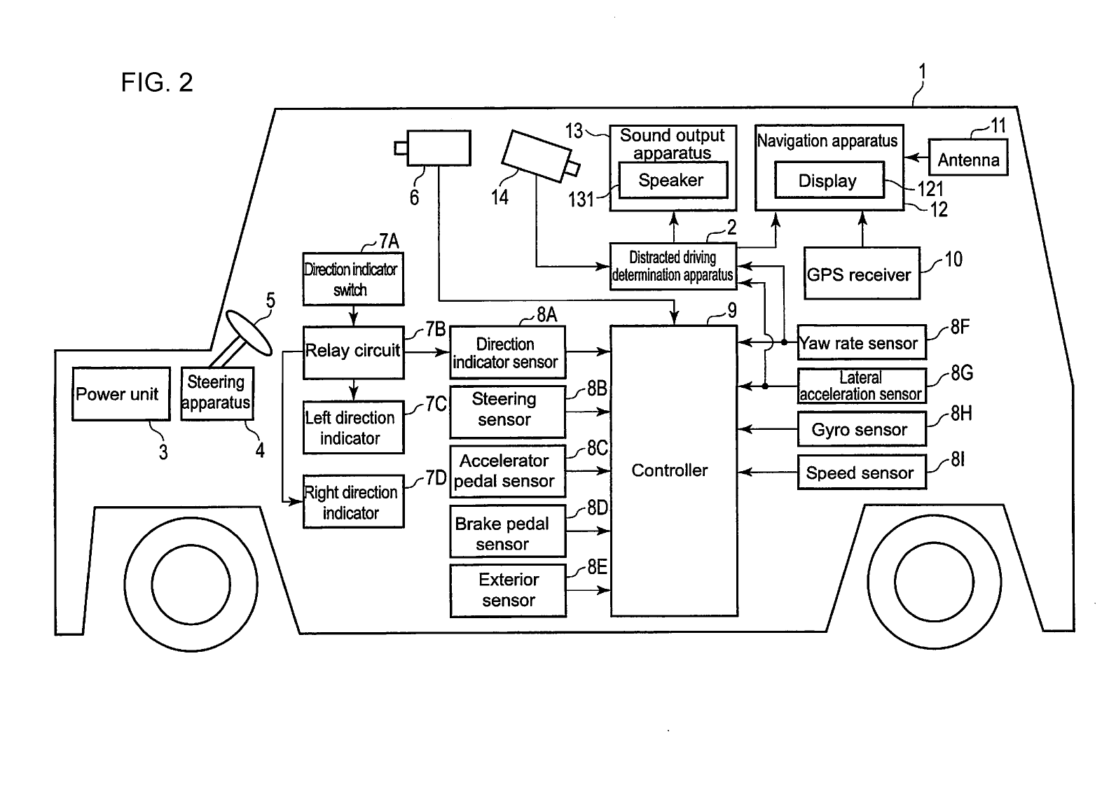

FIG. 2 is a schematic diagram of the vehicle 1 including the distracted driving determination apparatus 2. The vehicle 1 may be any of, for example, an automobile, a bus, a truck, and a train or may be any other vehicle drivable by a driver.

The vehicle 1 includes the distracted driving determination apparatus 2, a power unit 3, a steering apparatus 4, a steering wheel 5, an exterior view camera 6, a direction indicator switch 7A, a relay circuit 7B, a left direction indicator 7C, a right direction indicator 7D, a direction indicator sensor 8A, a steering sensor 8B, an accelerator pedal sensor 8C, a brake pedal sensor 8D, an exterior sensor 8E, a yaw rate sensor 8F, a lateral acceleration sensor 8G, a gyro sensor 8H, a speed sensor 8I, a controller 9, a global positioning system (GPS) receiver 10, an antenna apparatus 11, a navigation apparatus 12, a sound output apparatus 13, and a driver camera 14.

The distracted driving determination apparatus 2 determines whether the driver is engaging in distracted driving based on the gaze or face orientation of the driver and the distracted driving determination condition. The determination condition is defined by the multiple imaginary areas defined around the driver and a duration for which the gaze or face orientation of the driver associated with at least one of the multiple areas is allowed to be retained (hereafter, retention allowable duration). Examples of the determination conditions will be described later. Distracted driving may also be referred to as inattentive driving.

The components of the distracted driving determination apparatus 2 will be described later.

The power unit 3 includes a power source and a transmission. The power source includes an engine or a motor or both.

The steering apparatus 4 changes the traveling direction of the vehicle 1.

The steering wheel 5 is connected to the steering apparatus 4. The steering wheel 5 is operated by the driver to change the traveling direction of the vehicle 1.

The exterior view camera 6 captures an image of the exterior of the vehicle 1. For example, the exterior view camera 6 constantly captures images in front of the vehicle 1. The exterior view camera 6 outputs the captured images (hereafter, exterior image data) to the controller 9. The exterior view camera 6 is installed at a given position of the vehicle 1. Although FIG. 1 shows the single exterior view camera 6, the vehicle 1 may include multiple exterior view cameras 6 for capturing images in different directions.

The direction indicator switch 7A is operated by the driver to activate the left direction indicator 7C or the right direction indicator 7D when changing the traveling direction of the vehicle 1. When changing the traveling direction of the vehicle 1 leftward, the driver manually switches the direction indicator switch 7A from its initial position to a first position. When changing the traveling direction of the vehicle 1 rightward, the driver manually switches the direction indicator switch 7A from its initial position to a second position. The direction indicator switch 7A is manually switched by the driver from the first position or the second position back to the initial position. The direction indicator switch 7A may switch from the first position back to the initial position in cooperation with when the driver operating the steering wheel 5 counterclockwise operates the steering wheel 5 back to its initial position. Similarly, the direction indicator switch 7A may switch from the second position back to the initial position in cooperation with when the driver operating the steering wheel clockwise operates the steering wheel back to the initial position.

The relay circuit 7B supplies power to the left direction indicator 7C or the right direction indicator 7D in accordance with the position of the direction indicator switch 7A. The relay circuit 7B starts supplying power to the left direction indicator 7C in response to switching of the direction indicator switch 7A from the initial position to the first position. The relay circuit 7B continuously supplies power to the left direction indicator 7C while the direction indicator switch 7A is at the first position. The relay circuit 7B stops supplying power to the left direction indicator 7C in response to switching of the direction indicator switch 7A from the first position to the initial position. Similarly, the relay circuit 7B starts supplying power to the right direction indicator 7D in response to switching of the direction indicator switch 7A from the initial position to the second position. The relay circuit 7B continuously supplies power to the right direction indicator 7D while the direction indicator switch 7A is at the second position. The relay circuit 7B stops supplying power to the right direction indicator 7D in response to switching of the direction indicator switch 7A from the second position to the initial position.

The left direction indicator 7C is connected to the relay circuit 7B. The left direction indicator 7C includes, for example, a lightbulb or a light-emitting diode (LED). The left direction indicator 7C may be mounted on a left part of the vehicle 1. Although FIG. 1 shows the single left direction indicator 7C, the vehicle 1 includes multiple left direction indicators 7C at positions including a left front end and a left rear end of the vehicle 1. The left direction indicator 7C blinks when powered through the relay circuit 7B.

The right direction indicator 7D is connected to the relay circuit 7B. The right direction indicator 7D includes, for example, a lightbulb or an LED. The right direction indicator 7D may be mounted on a right part of the vehicle 1. Although FIG. 1 shows the single right direction indicator 7D, the vehicle 1 includes multiple right direction indicators 7D at multiple positions including a right front end and a right rear end of the vehicle 1. The right direction indicator 7D blinks when powered through the relay circuit 7B.

The direction indicator sensor 8A is included in the relay circuit 7B. The direction indicator sensor 8A detects an operation start and an operation end of the left direction indicator 7C based on the state of power supply to the left direction indicator 7C through the relay circuit 7B. The direction indicator sensor 8A detects an operation start and an operation end of the right direction indicator 7D based on the state of power supply to the right direction indicator 7D through the relay circuit 7B. The direction indicator sensor 8A outputs detection information indicating the operational state of each direction indicator to the controller 9. The direction indicator refers to either the left direction indicator 7C or the right direction indicator 7D. The detection information indicating the operational state of each direction indicator indicates an operational state selected from an operation start of the left direction indicator 7C, an operation end of the left direction indicator 7C, an operation start of the right direction indicator 7D, and an operation end of the right direction indicator 7D.

The steering sensor 8B detects a steering angle. The steering sensor 8B outputs detection information indicating the steering angle to the controller 9.

The accelerator pedal sensor 8C detects an operational quantity of an accelerator pedal. The accelerator pedal sensor 8C outputs detection information indicating the operational quantity of the accelerator pedal to the controller 9.

The brake pedal sensor 8D detects an operational quantity of a brake pedal. The brake pedal sensor 8D outputs detection information indicating the operational quantity of the brake pedal to the controller 9.

The exterior sensor 8E may be, for example, a millimeter wave sensor. The exterior sensor 8E detects the position of an object external to the vehicle 1. The exterior sensor 8E outputs detection information indicating the position of the object to the controller 9.

The yaw rate sensor 8F detects a rotational angle velocity about the vertical axis of the vehicle 1. The yaw rate sensor 8F outputs detection information indicating the rotational angle velocity to the distracted driving determination apparatus 2 and the controller 9.

The lateral acceleration sensor 8G detects an acceleration in a lateral direction (width direction) of the vehicle 1 (hereafter, lateral acceleration). The lateral acceleration sensor 8G outputs detection information indicating the lateral acceleration to the distracted driving determination apparatus 2 and the controller 9.

The gyro sensor 8H detects the behavior of the vehicle 1. The gyro sensor 8H outputs detection information indicating a quantity associated with the behavior of the vehicle 1 to the controller 9.

The speed sensor 8I detects the speed of the vehicle 1. The speed sensor 8I outputs detection information indicating the speed to the distracted driving determination apparatus 2 and the controller 9.

The controller 9 receives exterior image data from the exterior view camera 6 and detection information from the direction indicator sensor 8A, the steering sensor 8B, the accelerator pedal sensor 8C, the brake pedal sensor 8D, the exterior sensor 8E, the yaw rate sensor 8F, the lateral acceleration sensor 8G, the gyro sensor 8H, and the speed sensor 8I. The controller 9 uses detection information from at least one of these sensors to support driving of the vehicle 1.

The GPS receiver 10 receives GPS signals transmitted from multiple GPS satellites, and calculates the current location of the vehicle 1 based on the GPS signals. The GPS receiver 10 outputs information indicating the current location (hereafter, current location information) to the navigation apparatus 12.

The antenna apparatus 11 receives road traffic information, or specifically information from the Vehicle Information and Communication System (VICS, registered trademark), with at least one of frequency modulation (FM) multiplex broadcasting, a radio wave beacon, and a light beacon. The road traffic information includes, for example, traffic jam information and traffic control information. The antenna apparatus 11 transmits the road traffic information to the navigation apparatus 12.

The navigation apparatus 12 is an example of an image display device including a display 121 for displaying an image. The navigation apparatus 12 stores map data. The map data includes information about the features of roads.

The navigation apparatus 12 uses information about a destination input by, for example, the driver, map data, and current location information from the GPS receiver 10 to extract information about routes from the current location to the destination. The navigation apparatus 12 displays the route information on the display 121. The navigation apparatus 12 displays road traffic information from the antenna apparatus 11 on the display 121. The navigation apparatus 12 may display information other than the route information and the road traffic information on the display 121.

The sound output apparatus 13 includes a speaker 131. The sound output apparatus 13 outputs various items of information using sounds.

The driver camera 14 constantly captures images of a predefined range including the face of the driver. The driver camera 14 is installed in front of the driver, for example, on a dashboard. The driver camera 14 is an example of a sensor for monitoring the driver. The driver camera 14 captures images (hereafter, driver image data) and outputs the data to the distracted driving determination apparatus 2. The driver image data is an example of monitoring data used for detecting distracted driving of the driver.

### Distracted Driving Determination Apparatus

### Hardware Configuration

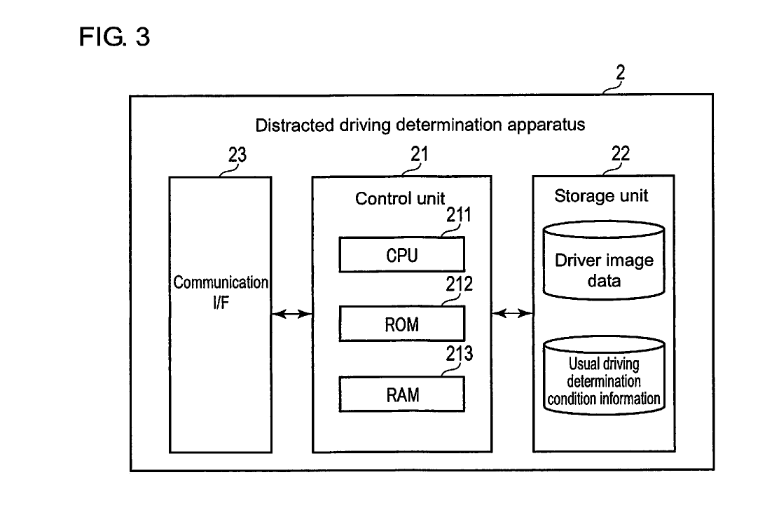

FIG. 3 is a block diagram of the distracted driving determination apparatus 2 showing its hardware configuration.

The distracted driving determination apparatus 2 includes a control unit 21, a storage unit 22, and a communication interface 23, which are electrically connected to one another. In FIG. 3, the communication interface is abbreviated as the communication I/F.

The control unit 21 will now be described.

The control unit 21 controls the operation of each unit in the distracted driving determination apparatus 2. The control unit 21 includes a central processing unit (CPU) 211, a read only memory (ROM) 212, and a random access memory (RAM) 213. The CPU 211 is an example of a processor. The CPU 211 expands, in the RAM 213, programs stored in the storage unit 22 for functioning the distracted driving determination apparatus 2. The CPU 211 then interprets and executes the programs expanded in the RAM 213. This allows the control unit 21 to implement the function of each unit in the software configuration described later.

The storage unit 22 will now be described.

The storage unit 22 is an auxiliary storage device. The storage unit 22 may be, but not limited to, a hard disk drive (HDD). The storage unit 22 stores programs executable by the control unit 21. The programs enable the distracted driving determination apparatus 2 to function as each unit in the software configuration described later. The programs may be stored in the storage unit 22, or may be downloaded to the distracted driving determination apparatus 2 through a network. The programs may be stored in a non-transitory computer-readable medium, such as a compact disc read-only memory (CD-ROM) and distributed.

The storage unit 22 stores data used by the control unit 21 as described below.

The storage unit 22 stores driver image data received from the driver camera 14 to the control unit 21. For example, the control unit 21 receives the driver image data from the driver camera 14 at predetermined intervals and stores the data into the storage unit 22.

The storage unit 22 stores information (usual driving determination condition information) indicating a determination condition for usual driving (usual driving determination condition), which is one determination condition for detecting distracted driving.

Usual driving herein refers to driving when the rotational angle velocity or the lateral acceleration satisfies a criterion. The criterion is associated with relaxing of the determination condition. The criterion is predefined. The criterion includes a first criterion associated with the left behavior and a second criterion associated with the right behavior. The first criterion is associated with relaxing of the determination condition for the left of the vehicle 1. The first criterion is predefined. The first criterion includes a reference value for the absolute value of the rotational angle velocity associated with left turning. The first criterion includes a reference value for the absolute value of the lateral acceleration associated with the direction from left to right of the vehicle 1 (hereafter, first direction). When the absolute value of the rotational angle velocity associated with left turning or the absolute value of the lateral acceleration associated with the first direction is greater than the reference value, the rotational angle velocity associated with left turning or the lateral acceleration associated with the first direction fails to satisfy the first criterion. The second criterion is associated with relaxing of the determination condition for the right of the vehicle 1. The second criterion is predefined. The second criterion includes a reference value for the absolute value of the rotational angle velocity associated with right turning. The second criterion includes a reference value for the absolute value of the lateral acceleration associated with the direction from right to left of the vehicle 1 (hereafter, second direction). When the absolute value of the rotational angle velocity associated with right turning or the absolute value of the lateral acceleration associated with the second direction is greater than the reference value, the rotational angle velocity associated with right turning or the lateral acceleration associated with the second direction fails to satisfy the second criterion. The reference value included in the first criterion or the reference value included in the second criterion may be set to any value. The reference value included in the first criterion may be the same as or different from the reference value included in the second criterion. Although the reference value included in the first criterion and the reference value included in the second criterion may be zero, the reference value may desirably be a value other than zero. This is because the vehicle 1 may have the rotational angle velocity or the lateral acceleration in accordance with, for example, road conditions when the driver does not intend to change the traveling direction of the vehicle 1.

Examples of the usual driving determination condition will be described later.

The communication interface 23 will now be described.

The communication interface 23 connects the yaw rate sensor 8F, the lateral acceleration sensor 8G, the navigation apparatus 12, the sound output apparatus 13, and the driver camera 14 to the control unit 21. The communication interface 23 may include an interface for cable communication or an interface for wireless communication.

For the specific hardware configuration of the distracted driving determination apparatus 2, components may be eliminated, substituted, or added as appropriate. For example, the control unit 21 may include multiple processors.

### Usual Driving Determination Condition

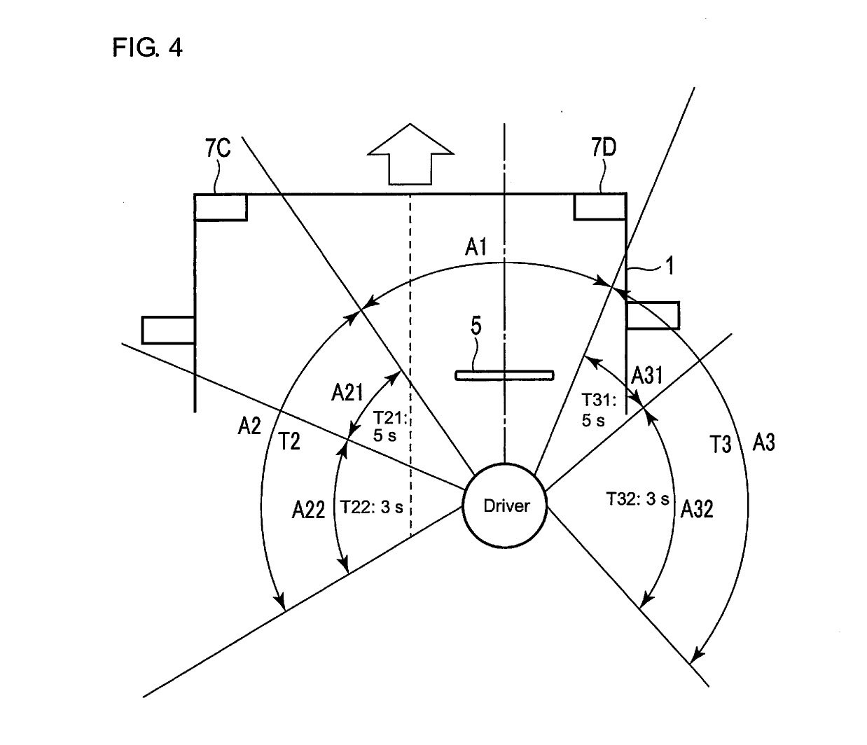

FIG. 4 is a schematic diagram describing a usual driving determination condition. FIG. 4 is a plan view of the vehicle 1 as viewed from above. The radial solid lines indicate the imaginary areas A1, A2, and A3. The broken line indicates the centerline in the width direction of the vehicle 1. The dot-and-dash line indicates the straight traveling direction of the vehicle 1.

The usual driving determination condition includes conditions for usual driving for the imaginary first area A1 horizontally ranging from the driver at the first angle, the imaginary second area A2 horizontally ranging from the driver at the second angle, and the imaginary third area A3 horizontally ranging from the driver at the third angle.

The first area A1 will now be described.

The first area A1 is an imaginary area horizontally ranging from the driver toward the front of the vehicle 1 at a first angle. The first area A1 is associated with driving with no distraction. More specifically, the first area A1 is not associated with any retention allowable duration. The distracted driving determination apparatus 2 thus determines that the driver is not engaging in distracted driving when his or her gaze or face orientation is retained within the first area A1 as described below.

The usual driving determination condition defines, for example, the first area A1 including the straight traveling direction of the vehicle 1. The usual driving determination condition defines the first angle as a predetermined angle. The predetermined angle may be set to any angle.

The second area A2 will now be described.

The second area A2 is an imaginary area adjacent to the first area A1 and horizontally ranging from the driver toward the left of the vehicle 1 at the second angle. The second area A2 is associated with a retention allowable duration T2. The retention allowable duration T2 is an example of the first duration for which the gaze or face orientation of the driver associated with at least a part of the second area A2 is allowed to be retained. As described later, the distracted driving determination apparatus 2 thus determines that the driver is engaging in distracted driving when his or her gaze or face orientation is retained within the second area A2 for a duration longer than the retention allowable duration T2.

The usual driving determination condition defines the position of the second area A2 using the boundary position between the first and second areas A1 and A2 and the second angle. The usual driving determination condition defines the boundary position between the first and second areas A1 and A2 as a predetermined position. The predetermined position may be set to any position. The usual driving determination condition defines the second angle as a predetermined angle. The predetermined angle may be set to any angle.

The usual driving determination condition defines the second area A2 including a sub-area A21 and a sub-area A22, which are associated with the retention allowable durations having different lengths.

The sub-area A21 is an imaginary area adjacent to the first area A1 and horizontally ranging at a fourth angle.

The usual driving determination condition defines the position of the sub-area A21 using the boundary position between the first and second areas A1 and A2 and the fourth angle. The usual driving determination condition defines the fourth angle as a predetermined angle. The predetermined angle may be set to any angle.

The length of a retention allowable duration T21, which is associated with the sub-area A21, may be, but not limited to, five seconds. The retention allowable duration T21 is an example of the first duration.

The sub-area A22 is an imaginary area adjacent to the sub-area A21 and horizontally ranging at a fifth angle.

The usual driving determination condition defines the position of the sub-area A22 using the position of the sub-area A21 and the fifth angle. The usual driving determination condition defines the fifth angle as a predetermined angle. The predetermined angle may be set to any angle.

The length of a retention allowable duration T22, which is associated with the sub-area A22, may be, but not limited to, three seconds. The retention allowable duration T22 is an example of the first duration. The retention allowable duration T22 associated with the sub-area A22 is shorter than the retention allowable duration T21 associated with the sub-area A21. This is because the sub-area A22 is located rearward from the sub-area A21 in the vehicle 1 and thus is likely to affect the safety of driving when the gaze or face orientation of the driver is retained within the sub-area A22 for a long time whether or not for distracted driving or for checking for any obstacle before turning.

Although the second area A2 includes two sub-areas, the second area A2 may include no sub-area. In some embodiments, the second area A2 may include three or more sub-areas. In this case, the retention allowable duration associated with each sub-area is shorter as the sub-area is farther from the boundary between the first and second areas A1 and A2 counterclockwise as viewed from the driver.

The third area A3 will now be described.

The third area A3 is an imaginary area adjacent to the first area A1 and horizontally ranging at the third angle. The third area A3 is associated with a retention allowable duration T3. The retention allowable duration T3 is an example of the second duration for which the gaze or face orientation of the driver associated with at least a part of the third area is allowed to be retained. As described later, the distracted driving determination apparatus 2 thus determines that the driver is engaging in distracted driving when his or her gaze or face orientation is retained within the third area A3 for a duration longer than the retention allowable duration T3.

The usual driving determination condition defines the position of the third area A3 using the boundary position between the first and third areas A1 and A3 and the third angle. The usual driving determination condition defines the boundary position between the first and third areas A1 and A3 as a predetermined position. The predetermined position may be set to any position. The usual driving determination condition defines the third angle as a predetermined angle. The predetermined angle may be set to any angle.

The usual driving determination condition defines the third area A3 including a sub-area A31 and a sub-area A32, which are associated with retention allowable durations having different lengths.

The sub-area A31 is an imaginary area adjacent to the first area A1 and horizontally ranging at a sixth angle.

The usual driving determination condition defines the position of the sub-area A31 using the boundary position between the first and third areas A1 and A3 and the sixth angle. The usual driving determination condition defines the sixth angle as a predetermined angle. The predetermined angle may be set to any angle.

The length of a retention allowable duration T31, which is associated with the sub-area A31, may be, but not limited to, five seconds. The retention allowable duration T31 is an example of the second duration.

The sub-area A32 is an imaginary area adjacent to the sub-area A31 and horizontally ranging at a seventh angle.

The usual driving determination condition defines the position of the sub-area A32 using the position of the sub-area A31 and the seventh angle. The usual driving determination condition defines the seventh angle as a predetermined angle. The predetermined angle may be set to any angle.

The length of a retention allowable duration T32, which is associated with the sub-area A32, may be, but not limited to, three seconds. The retention allowable duration T32 is an example of the second duration. The retention allowable duration T32 associated with the sub-area A32 is shorter than the retention allowable duration T31 associated with the sub-area A31. This is because the sub-area A32 is located rearward from the sub-area A31 in the vehicle 1 and thus is likely to affect the safety of driving when the gaze or face orientation of the driver is retained within the sub-area A32 for a long time whether or not for distracted driving or for checking for any obstacle before turning.

Although the third area A3 includes two sub-areas, the third area A3 may include no sub-area. In some embodiments, the third area A3 may include three or more sub-areas. In this case, the retention allowable duration associated with each sub-area is shorter as the sub-area is farther from the boundary between the first and third areas A1 and A3 clockwise as viewed from the driver.

The deviation (angle) of the boundary between the first and second areas A1 and A2 from the straight traveling direction of the vehicle 1 may or may not have the same absolute value as the deviation (angle) of the boundary between the first and third areas A1 and A3 from the straight traveling direction of the vehicle 1. The deviation (angle) of the boundary between the sub-areas A21 and A22 from the straight traveling direction of the vehicle 1 may or may not have the same absolute value as the deviation (angle) of the boundary between the sub-areas A31 and A32 from the straight traveling direction of the vehicle 1.

### Software Configuration

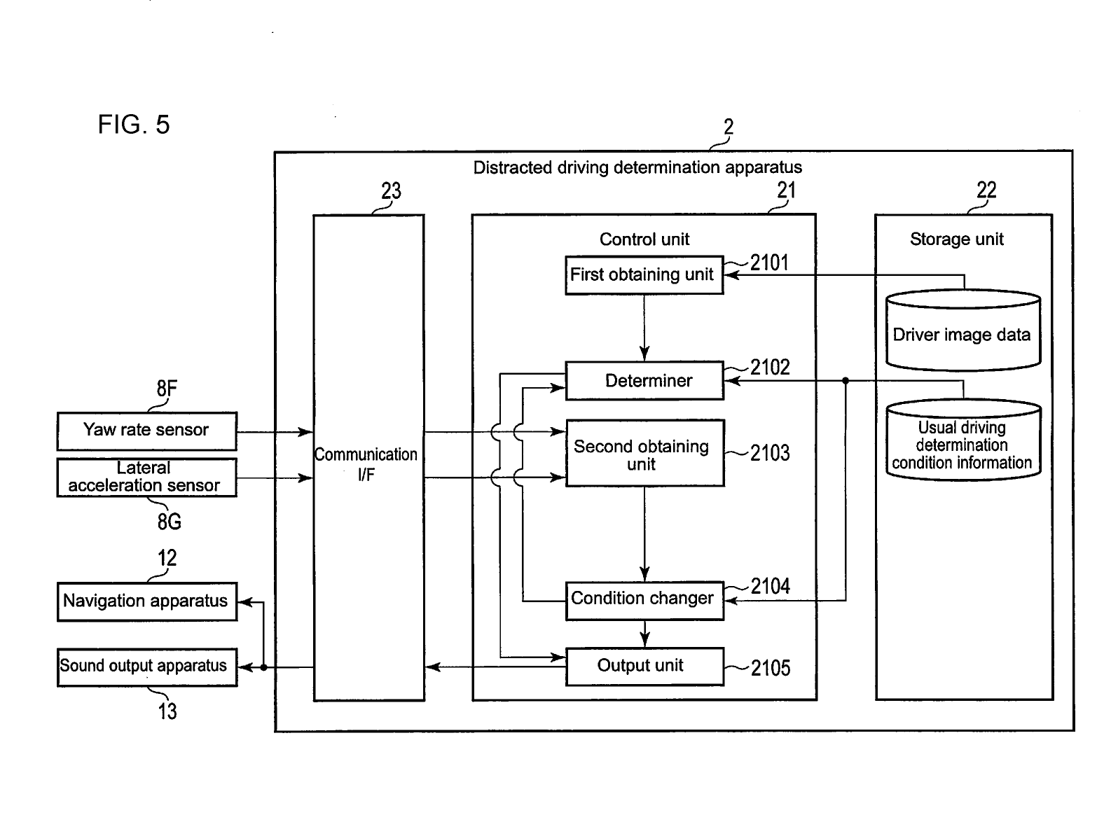

FIG. 5 is a block diagram of the distracted driving determination apparatus 2 showing its software configuration.

The control unit 21 includes a first obtaining unit 2101, a determiner 2102, a second obtaining unit 2103, a condition changer 2104, and an output unit 2105.

The first obtaining unit 2101 will now be described.

The first obtaining unit 2101 obtains first detection information indicating the gaze or face orientation of the driver as described below.

The first obtaining unit 2101 first obtains the driver image data for the driver of the vehicle 1. The first obtaining unit 2101 may constantly obtain the driver image data from the storage unit 22. In some embodiments, the first obtaining unit 2101 may constantly obtain the driver image data from the driver camera 14. The first obtaining unit 2101 then determines, for example, the state of the eyes of the driver captured in the driver image data to detect the gaze or face orientation of the driver. Thus, the first obtaining unit 2101 obtains detection information indicating the gaze or face orientation of the driver (hereafter, first detection information).

The first obtaining unit 2101 outputs the first detection information to the determiner 2102.

The determiner 2102 will now be described.

As illustrated below, the determiner 2102 determines whether the driver is engaging in distracted driving based on the first detection information indicating the gaze or face orientation of the driver and the determination condition.

The determiner 2102 first receives the first detection information from the first obtaining unit 2101. The determiner 2102 then obtains the determination condition. When the distracted driving determination apparatus 2 is activated, the determiner 2102 obtains the usual driving determination condition information from the storage unit 22 and uses the usual driving determination condition. When the determination condition is changed by the condition changer 2104 (described later), the determiner 2102 receives information specifying the changed determination condition from the condition changer 2104. The determiner 2102 may use the resultant determination condition.

The determiner 2102 first determines the area including the gaze or face orientation of the driver based on the first detection information. The determiner 2102 then determines that the driver is not engaging in distracted driving when the gaze or face orientation of the driver is within the first area A1. The determiner 2102 determines a duration for which the gaze or face orientation of the driver is retained within the second area A2 or the third area A3 when the gaze or face orientation of the driver is within the areas. For example, the duration for which the gaze or face orientation of the driver is retained continuously within an identified area is calculated based on the past detection results of the gaze or face orientation of the driver. The determiner 2102 then determines that the driver is engaging in distracted driving when the retention duration of the gaze or face orientation within the second area A2 is longer than the retention allowable duration T2, which is preset for the second area A2. In other words, the determiner 2102 determines that the driver is not engaging in distracted driving when the gaze or face orientation is retained within the second area A2 within the retention allowable duration T2.

The determiner 2102 determines that the driver is engaging in distracted driving when the retention duration of the gaze or face orientation within the third area A3 is longer than the retention allowable duration T3 of the gaze or face orientation of the driver, which is preset for the third area A3. In other words, the determiner 2102 determines that the driver is not engaging in distracted driving when the gaze or face orientation of the driver is retained within the third area A3 within the retention allowable duration T3.

In response to detected distracted driving, the determiner 2102 outputs a determination result indicating detected distracted driving to the output unit 2105.

The second obtaining unit 2103 will now be described.

The second obtaining unit 2103 obtains detection information indicating the rotational angle velocity or lateral acceleration (hereafter, second detection information) as described below. The second obtaining unit 2103 obtains second detection information indicating the rotational angle velocity from the yaw rate sensor 8F. The second obtaining unit 2103 obtains second detection information indicating the lateral acceleration from the lateral acceleration sensor 8G. The second obtaining unit 2103 outputs the second detection information to the condition changer 2104.

The condition changer 2104 will now be described.

As described below, the condition changer 2104 changes the determination condition.

The condition changer 2104 first receives the usual driving determination condition from the storage unit 22. The condition changer 2104 then receives the second detection information from the second obtaining unit 2103.

Based on the second detection information, the condition changer 2104 determines the absolute value of the rotational angle velocity associated with left turning or the absolute value of the rotational angle velocity associated with right turning. Based on the second detection information, the condition changer 2104 determines the absolute value of the lateral acceleration associated with the direction from left to right of the vehicle 1 (hereafter, first direction) or the absolute value of the lateral acceleration associated with the direction from right to left of the vehicle 1 (hereafter, second direction).

The condition changer 2104 then compares the rotational angle velocity or the lateral acceleration with a reference to detect a duration for which the rotational angle velocity or the lateral acceleration fails to satisfy the criterion. The condition changer 2104 compares the absolute value of the rotational angle velocity associated with left turning with a reference value included in the first criterion to detect a duration for which the rotational angle velocity associated with left turning is failing to satisfy the first criterion. The condition changer 2104 compares the absolute value of the rotational angle velocity associated with right turning with a reference value included in the second criterion to detect a duration for which the rotational angle velocity associated with right turning is failing to satisfy the second criterion. The condition changer 2104 compares the absolute value of the lateral acceleration associated with the first direction with a reference value included in the first criterion to detect a duration for which the lateral acceleration associated with the first direction is failing to satisfy the first criterion. The condition changer 2104 compares the absolute value of the lateral acceleration associated with the second direction with a reference value included in the second criterion to detect a duration for which the lateral acceleration associated with the second direction is failing to satisfy the second criterion.

The condition changer 2104 changes the determination condition to use the changed determination condition in the duration for which the rotational angle velocity or lateral acceleration failing to satisfy the criterion is being detected based on the second detection information. The determination condition is changed to lower the likelihood that distracted driving is detected.

The condition changer 2104 changes the determination condition for determining distracted driving for the left of the vehicle 1 to use the changed determination condition in the duration for which the rotational angle velocity associated with left turning or the lateral acceleration associated with the first direction failing to satisfy the first criterion is being detected based on the second detection information, or in other words, in a duration for which the vehicle 1 is determined to be turning left as described below.

In response to detection of the rotational angle velocity associated with left turning or the lateral acceleration associated with the first direction failing to satisfy the first criterion, the condition changer 2104 performs a first change process at least by shifting the boundary between the first and second areas A1 and A2 to a position rotated counterclockwise as viewed from the driver from the boundary position when the rotational angle velocity or the lateral acceleration satisfies the criterion, or by extending the first duration in the second area A2. The determination condition resulting from the first change process for the usual driving determination condition is referred to as the left determination condition. The condition changer 2104 determines to use the left determination condition. In response to detection of the end of the duration for which the rotational angle velocity associated with left turning or the lateral acceleration associated with the first direction is failing to satisfy the first criterion, or in other words, detection of the end of the duration for which the vehicle is determined to be turning left, the condition changer 2104 changes the determination condition from the left determination condition back to the usual driving determination condition. The condition changer 2104 determines to use the usual driving determination condition.

The condition changer 2104 changes the determination condition for determining distracted driving for the right of the vehicle 1 and uses the changed determination condition in the duration for which the rotational angle velocity associated with right turning or the lateral acceleration associated with the second direction failing to satisfy the second criterion is being detected, or in other words, in a duration for which the vehicle 1 is determined to be turning right as described below based on the second detection information.

In response to detection of the rotational angle velocity associated with right turning or the lateral acceleration associated with the second direction failing to satisfy the second criterion, the condition changer 2104 performs a second change process at least by shifting the boundary between the first and third areas A1 and A3 to a position rotated clockwise as viewed from the driver from the position when the rotational angle velocity or the lateral acceleration satisfies the criterion, or by extending the second duration in the third area A3. The determination condition resulting from the second change process is referred to as the right determination condition to differentiate from the usual driving determination condition. The condition changer 2104 determines to use the right determination condition. In response to detection of the end of the duration for which the rotational angle velocity associated with right turning or the lateral acceleration associated with the second direction is failing to satisfy the second criterion, or in other words, detection of the end of the duration for which the vehicle is determined to be turning right, the condition changer 2104 changes the determination condition from the right determination condition back to the usual driving determination condition. The condition changer 2104 determines to use the usual driving determination condition.

The condition changer 2104 outputs information specifying the determination condition to the determiner 2102 upon every change of the determination condition. The information specifying the determination condition may be information indicating the usual driving determination condition, the left determination condition, or the right determination condition.

The output unit 2105 will now be described.

As described below, the output unit 2105 outputs an instruction signal to support the driver based on the determination result indicating that the driver is engaging in distracted driving.

The output unit 2105 first obtains the determination result indicating that the driver is engaging in distracted driving from the determiner 2102. The output unit 2105 then outputs an instruction signal to a support apparatus based on the determination result indicating that the driver is engaging in distracted driving.

The support apparatus may include the navigation apparatus 12 and the sound output apparatus 13. The support apparatus may include, for example, an apparatus that externally stimulates the driver by providing vibrations for example, in addition to the navigation apparatus 12 and the sound output apparatus 13. The support apparatus that has received the instruction signal from the output unit 2105 starts supporting the driver. Supporting the driver includes providing an output that acts on the driver, including an alert, a caution, and notification, and various other forms of support to improve the driver's focus on driving.

### Left Determination Condition

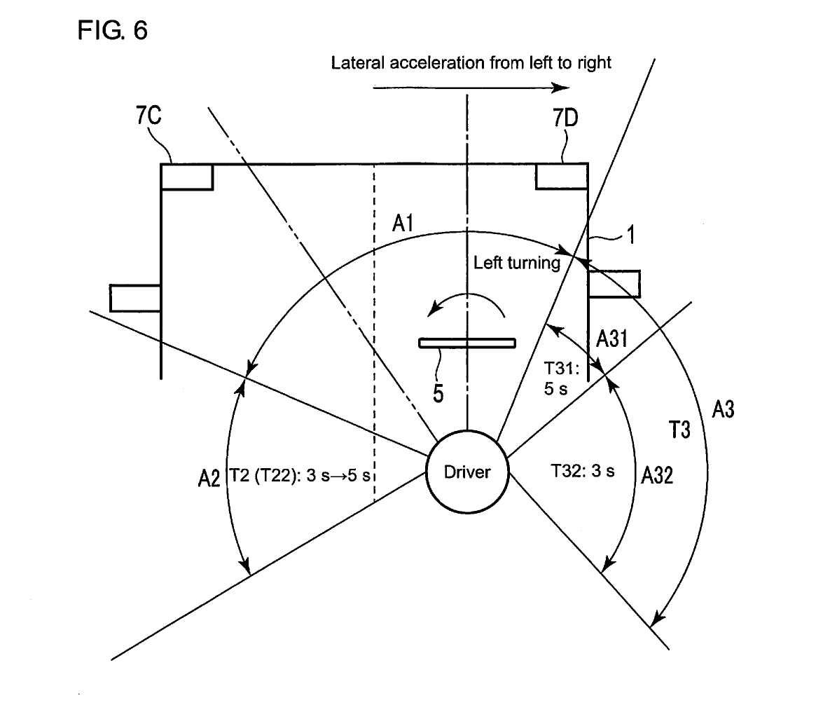

FIG. 6 is a schematic diagram describing the left determination condition resulting from the first change process for the usual driving criterion. In the example shown in FIG. 6, the boundary between the first and second areas A1 and A2 is shifted and the first duration is extended for the usual driving determination condition. FIG. 6 shows the vehicle 1 as viewed from above. The radial solid lines indicate the imaginary areas A1, A2, and A3. The broken line indicates the centerline in the width direction of the vehicle 1. The dot-and-dash line indicates the straight traveling direction of the vehicle 1. The two-dot chain line indicates the boundary position between the first and second areas A1 and A2 under the usual driving determination condition. The rotational angle velocity associated with left turning or the lateral acceleration associated with the first direction fails to satisfy the first criterion.

The left determination condition will be described below with reference to FIG. 6. The left determination condition below is a mere example, and may be any determination condition under which distracted driving is less likely to be detected for the left of the vehicle 1 than under the usual driving determination condition in which the vehicle 1 is determined to be traveling straight.

The first area A1 and the second area A2 will be described first.

The first area A1 and the second area A2 together are at the same positions and in the same ranges as under the usual driving determination condition. The boundary position between the first and second areas A1 and A2 differs from the position under the usual driving determination condition. The boundary position between the first and second areas A1 and A2 corresponds to the boundary position between the sub-areas A21 and A22 under the usual driving determination condition. In other words, the boundary between the first and second areas A1 and A2 is at a position rotated counterclockwise as viewed from the driver from the boundary position under the usual driving determination condition.

The first angle of the first area A1 is larger than the angle under the usual driving determination condition. Thus, the range of the first area A1 under the left determination condition is enlarged more than the range of the first area A1 under the usual driving determination condition.

The end of the second area A2, which is located opposite to the boundary between the first and second areas A1 and A2, is at the same position as under the usual driving determination condition. The second angle of the second area A2 is smaller than the angle under the usual driving determination condition, and is the same as the angle of the sub-area A22 under the usual driving determination condition. The position of the second area A2 corresponds to the position of the sub-area A22 under the usual driving determination condition. Thus, the range of the second area A2 under the left determination condition is reduced from the range of the second area A2 under the usual driving determination condition.

The length of the first duration will now be described. The retention allowable duration T2 (e.g., 5 seconds) associated with the second area A2 under the left determination condition is longer than the retention allowable duration T22 (3 seconds) associated with the sub-area A22 under the usual driving determination condition.

When the process for shifting the boundary between the first and second areas A1 and A2 is eliminated, the retention allowable duration T21 associated with the sub-area A21 under the left determination condition is longer than that under the usual driving determination condition. Similarly, the retention allowable duration T22 associated with the sub-area A22 under the left determination condition is longer than that under the usual driving determination condition. Under the left determination condition, the retention allowable duration T21 associated with the sub-area A21 may or may not be the same as the retention allowable duration T22 associated with the sub-area A22.

The process for extending the first duration may be eliminated when the process for shifting the boundary between the first and second areas A1 and A2 is performed.

The third area A3 will now be described.

The boundary between the first and third areas A1 and A3 is at the same position as under the usual driving determination condition. The end of the third area A3, which is located opposite to the boundary between the first and third areas A1 and A3, is at the same position as under the usual driving determination condition. The third angle of the third area A3 is the same as the angle under the usual driving determination condition. Thus, the position and the range of the third area A3 are the same as those under the usual driving determination condition. The sixth angle of the sub-area A31 is the same as the angle under the usual driving determination condition. Thus, the position and the range of the sub-area A31 are the same as those under the usual driving determination condition. The length of the retention allowable duration T31 associated with the sub-area A31 is the same as the length under the usual driving determination condition. The seventh angle of the sub-area A32 is the same as the angle under the usual driving determination condition. Thus, the position and the range of the sub-area A32 are the same as those under the usual driving determination condition. The length of the retention allowable duration T32 associated with the sub-area A32 is the same as the length under the usual driving determination condition.

Thus, the positions and the ranges of the third area A3, the sub-area A31, and the sub-area A32, and the retention allowable duration T31 associated with the sub-area A31 and the retention allowable duration T32 associated with the sub-area A32 are the same for the left determination condition and the usual driving determination condition. This is because the driver is unlikely to look to the right of the vehicle 1 during changing the traveling direction to the left relative to the straight direction, and thus the distracted driving determination condition defined for the right of the vehicle 1 may not be changed to a value to lower the likelihood that distracted driving of the driver is detected.

The left determination condition may be defined as described below.

The boundary position between the first and second areas A1 and A2 may differ between the vehicles 1 with the right driver's seat and the left driver's seat. The first duration may differ between the vehicles 1 with the right driver's seat and the left driver's seat. The boundary position between the first and second areas A1 and A2 may differ from the boundary position between the sub-areas A21 and A22 under the usual driving determination condition. The second angle of the second area A2 may be greater than the fifth angle of the sub-area A22 under the usual driving determination condition. The end of the second area A2, which is located opposite to the boundary between the first and second areas A1 and A2, may be shifted counterclockwise as viewed from the driver from the position under the usual driving determination condition when the boundary position between the first and second areas A1 and A2 is shifted. The boundary position between the first and third areas A1 and A3 may differ from the position under the usual driving determination condition. The third angle of the third area A3 may differ from the angle under the usual driving determination condition. The sixth angle of the sub-area A31 and the seventh angle of the sub-area A32 may differ from those under the usual driving determination condition. The length of the retention allowable duration T31 associated with the sub-area A31 may differ from the length under the usual driving determination condition. The length of the retention allowable duration T32 associated with the sub-area A32 may differ from the length under the usual driving determination condition. The retention allowable duration T31 associated with the sub-area A31 may be the same as the retention allowable duration T32 associated with the sub-area A32.

### Right Determination Condition

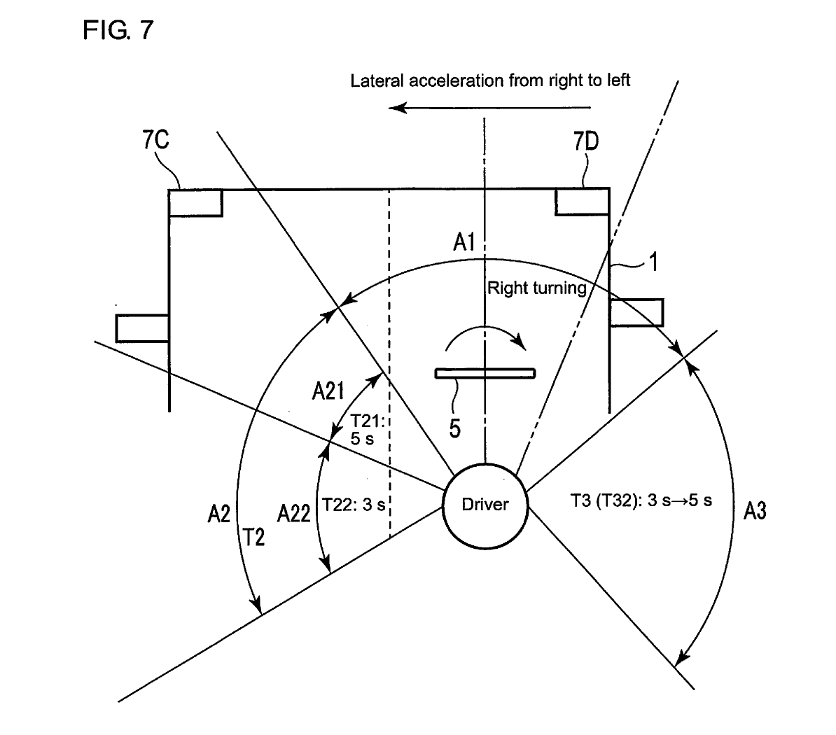

FIG. 7 is a schematic diagram describing the right determination condition resulting from the second change process for the usual driving determination condition. In the example shown in FIG. 7, the boundary between the first and third areas A1 and A3 is shifted and the second duration is extended for the usual driving determination condition. FIG. 7 shows the vehicle 1 as viewed from above. The radial solid lines indicate the imaginary areas A1, A2, and A3. The broken line indicates the centerline in the width direction of the vehicle 1. The dot-and-dash line indicates the straight traveling direction of the vehicle 1. The two-dot chain line indicates the boundary position between the first and third areas A1 and A3 under the usual driving determination condition. The rotational angle velocity associated with right turning or the lateral acceleration associated with the second direction fails to satisfy the second criterion.

The right determination condition will be described below with reference to FIG. 7. The right determination condition described below is a mere example, and may be any condition for the right of the vehicle 1 changed from the usual driving determination condition to lower the likelihood that distracted driving of the driver is detected.

The first area A1 and the third area A3 will be described first.

The first area A1 and the third area A3 together are at the same positions and in the same ranges as under the usual driving determination condition. The boundary position between the first and third areas A1 and A3 differs from the position under the usual driving determination condition. The boundary position between the first and third areas A1 and A3 may corresponds to the boundary position between the sub-areas A31 and A32 under the usual driving determination condition. In other words, the boundary between the first and third areas A1 and A3 is at a position rotated clockwise as viewed from the driver from the boundary position under the usual driving determination condition.

The first angle of the first area A1 is greater than the angle under the usual driving determination condition. Thus, the range of the first area A1 under the right determination condition is enlarged more than the range of the first area A1 under the usual driving determination condition.

The end of the third area A3, which is located opposite to the boundary between the first and third areas A1 and A3, is at the same position as under the usual driving determination condition. The third angle of the third area A3 is smaller than the angle under the usual driving determination condition, and is the same as the angle of the sub-area A32 under the usual driving determination condition. The position of the third area A3 corresponds to the position of the sub-area A32 under the usual driving determination condition. Thus, the range of the third area A3 under the right determination condition is reduced from the range of the third area A3 under the usual driving determination condition.

The length of the second duration will now be described.

The retention allowable duration T3 (e.g., 5 seconds) associated with the third area A3 under the right determination condition is longer than the retention allowable duration T32 (3 seconds) associated with the sub-area A32 under the usual driving determination condition.

When the process for shifting the boundary between the first and third areas A1 and A3 is eliminated, the retention allowable duration T31 associated with the sub-area A31 under the right determination condition is longer than the duration under the usual driving determination condition. Similarly, the retention allowable duration T32 associated with the sub-area A32 under the right determination condition is longer than the duration under the usual driving determination condition. Under the right determination condition, the retention allowable duration T31 associated with the sub-area A31 may or may not be the same as the retention allowable duration T32 associated with the sub-area A32.

The process for extending the second duration may be eliminated when the process for shifting the boundary between the first and third areas A1 and A3 is performed.

The second area A2 will now be described.

The boundary position between the first and second areas A1 and A2 is at the same position as under the usual driving determination condition. The end of the second area A2, which is located opposite to the boundary between the first and second areas A1 and A2, is at the same position as under the usual driving determination condition. The second angle of the second area A2 is the same as the angle under the usual driving determination condition. Thus, the position and the range of the second area A2 are the same as those under the usual driving determination condition. The fourth angle of the sub-area A21 is the same as the angle under the usual driving determination condition. Thus, the position and the range of the sub-area A21 are the same as those under the usual driving determination condition. The length of the retention allowable duration T21 associated with the sub-area A21 is the same as the length under the usual driving determination condition. The fifth angle of the sub-area A22 is the same as the angle under the usual driving determination condition. Thus, the position and the range of the sub-area A22 are the same as those under the usual driving determination condition. The length of the retention allowable duration T22 associated with the sub-area A22 is the same as the length under the usual driving determination condition.

Thus, the positions and the ranges of the second area A2, the sub-area A21, and the sub-area A22, and the retention allowable duration T21 associated with the sub-area A21 and the retention allowable duration T22 associated with the sub-area A22 are the same for the right determination condition and the usual driving determination condition. This is because the driver is unlikely to look to the left of the vehicle 1 during changing the traveling direction to the right relative to the straight direction, and thus the distracted driving determination condition defined for the left of the vehicle 1 may not be relaxed.

The right determination condition may be defined as described below.

The boundary position between the first and third areas A1 and A3 may differ between the vehicles 1 with the right driver's seat and the left driver's seat. The second duration may differ between the vehicles 1 with the right driver's seat and the left driver's seat. The deviation (angle) of the boundary between the first and third areas A1 and A3 under the right determination condition from the straight traveling direction of the vehicle 1 may or may not have the same absolute value as the deviation (angle) of the boundary between the first and second areas A1 and A2 under the left determination condition from the straight traveling direction of the vehicle 1. The length of the second duration under the right determination condition may or may not be the same as the length of the first duration under the left determination condition. The boundary position between the first and third areas A1 and A3 may differ from the boundary position between the sub-areas A31 and A32 under the usual driving determination condition. The third angle of the third area A3 may be greater than the seventh angle of the sub-area A32 under the usual driving determination condition. The end of the third area A3, which is located opposite to the boundary between the first and third areas A1 and A3, may be shifted clockwise as viewed from the driver from the position under the usual driving determination condition when the boundary position between the first and third areas A1 and A3 is shifted. The boundary position between the first and second areas A1 and A2 may differ from the position under the usual driving determination condition. The second angle of the second area A2 may differ from the angle under the usual driving determination condition. The fourth angle of the sub-area A21 and the fifth angle of the sub-area A22 may differ from those under the usual driving determination condition. The length of the retention allowable duration T21 associated with the sub-area A21 may differ from the length under the usual driving determination condition. The length of the retention allowable duration T22 associated with the sub-area A22 may differ from the length under the usual driving determination condition. The retention allowable duration T21 associated with the sub-area A21 may be the same as the retention allowable duration T22 associated with the sub-area A22.

### 3. OPERATION EXAMPLES

### Distracted Driving Determination Apparatus

### Operation for Determining Distracted Driving

The operation for determining distracted driving performed by the distracted driving determination apparatus 2 will now be described.

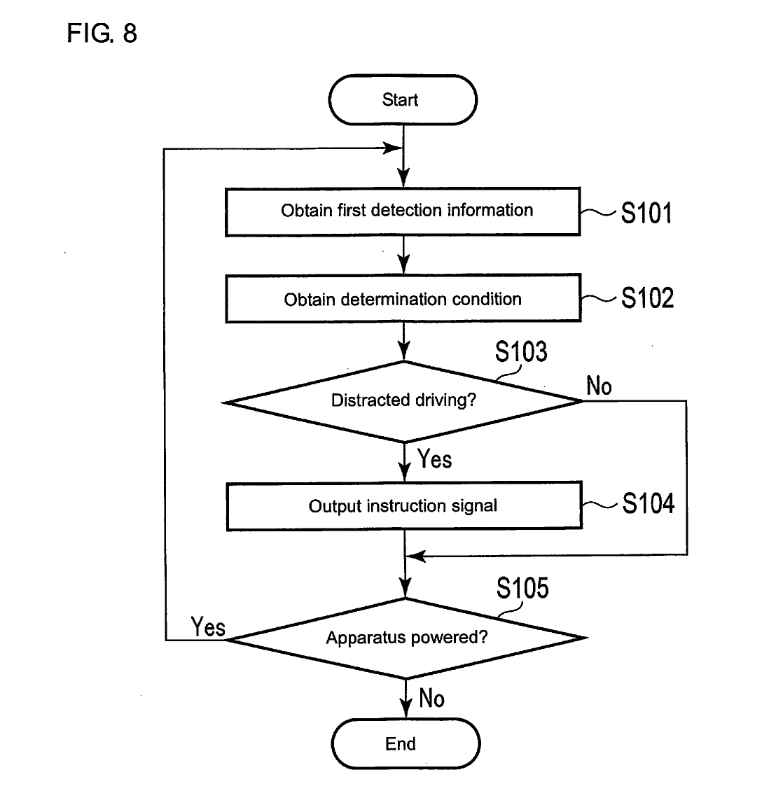

FIG. 8 is a flowchart showing distracted driving determination performed by the distracted driving determination apparatus 2. The procedure described below is a mere example, and each of its processes may be modified. In the procedure described below, steps may be eliminated, substituted, or added as appropriate.

As described above, the first obtaining unit 2101 obtains the first detection information indicating the gaze or face orientation of the driver (step S101).

As described above, the determiner 2102 obtains the determination condition defined to determine distracted driving (step S102).

As described above, the determiner 2102 determines whether the driver is engaging in distracted driving based on the first detection information indicating the gaze or face orientation of the driver and the determination condition (step S103). When the determiner 2102 determines that the driver is engaging in distracted driving (Yes in step S103), the output unit 2105 outputs an instruction signal (step S104) as described above.

The control unit 21 determines whether the distracted driving determination apparatus 2 is powered (step S105). When the distracted driving determination apparatus 2 is powered (Yes in step S105), the control unit 21 repeats the processing in step S101 and subsequent steps. The control unit 21 ends the distracted driving determination when the power supply to the distracted driving determination apparatus 2 is stopped (No in step S105).

Returning to step S103, when determining that the driver is not engaging in distracted driving (No in step S103), the control unit 21 performs the processing in step S105 as described above.

### Example of Determination Condition Change Operation

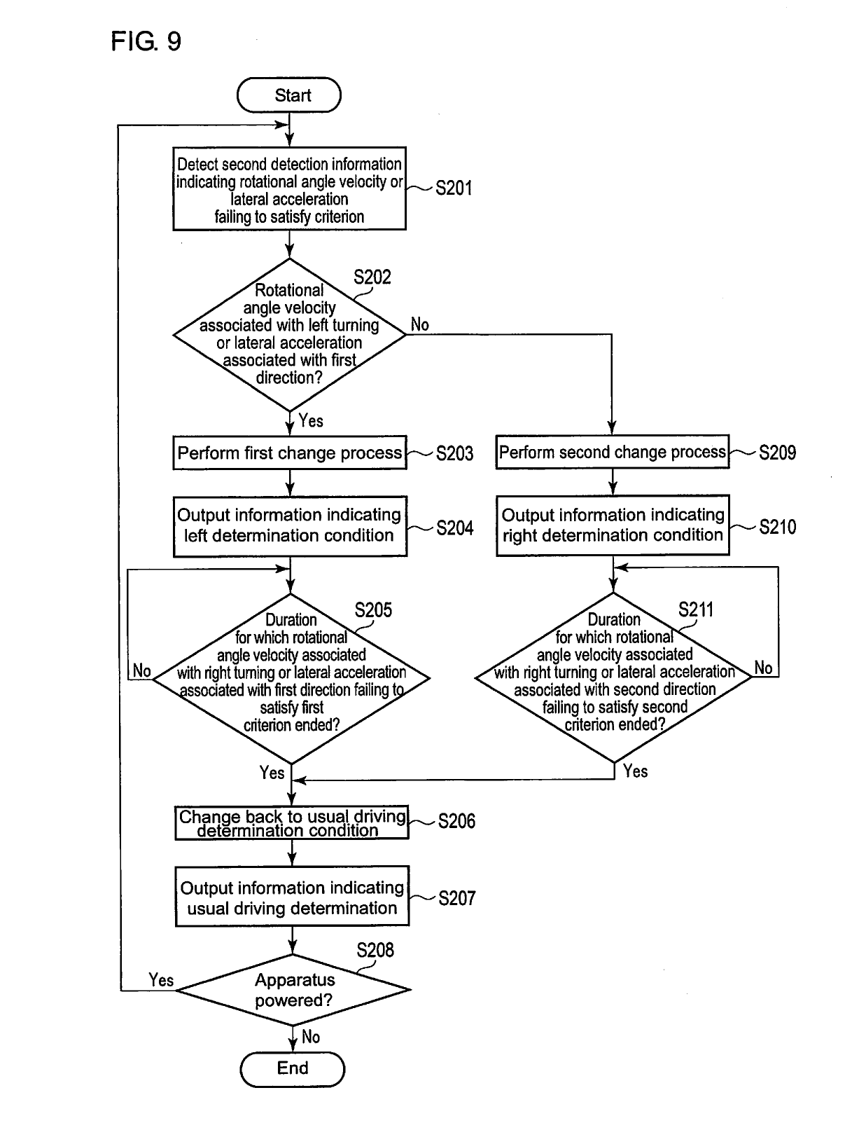

FIG. 9 is a flowchart showing an example operation for changing the determination condition performed by the distracted driving determination apparatus 2. The procedure described below is a mere example, and each of its processes may be modified. In the procedure described below, steps may be eliminated, substituted, or added as appropriate.

Based on the second detection information, the condition changer 2104 detects the rotational angle velocity or lateral acceleration that fails to satisfy the criterion (step S201).

The condition changer 2104 determines whether the rotational angle velocity associated with left turning or the lateral acceleration associated with the first direction failing to satisfy the first criterion is being detected (step S202).

When detecting the rotational angle velocity associated with left turning or the lateral acceleration associated with the first direction failing to satisfy the first criterion (Yes in step S202), the condition changer 2104 performs the first change process for the usual driving determination condition (step S203). The condition changer 2104 determines to use the left determination condition, and outputs information indicating the left determination condition to the determiner 2102 (step S204).

The condition changer 2104 determines whether the end of the duration for which the rotational angle velocity associated with left turning or the lateral acceleration associated with the first direction failing to satisfy the first criterion is detected (step S205). When determining that the end of the duration for which the rotational angle velocity associated with left turning or the lateral acceleration associated with the first direction failing to satisfy the first criterion is not detected (No in step S205), the condition changer 2104 continues the processing in step S205.

In response to detection of the end of the duration for which the rotational angle velocity associated with left turning or the lateral acceleration associated with the first direction is failing to satisfy the first criterion (Yes in step S205), the condition changer 2104 changes the determination condition from the left determination condition back to the usual driving determination condition (step S206). The condition changer 2104 determines to use the usual driving determination condition, and outputs information indicating the usual driving determination condition to the determiner 2102 (step S207).

The condition changer 2104 determines whether the distracted driving determination apparatus 2 has been powered (step S208). When the distracted driving determination apparatus 2 has been powered (Yes in step S208), the condition changer 2104 repeats the processing in step S201 and subsequent steps. In response to a stop of the power supply to the distracted driving determination apparatus 2 (No in step S208), the condition changer 2104 ends the distracted driving determination.

Returning to step S202, when detecting no rotational angle velocity associated with left turning or no lateral acceleration associated with the first direction failing to satisfy the first criterion (No in step S202), the condition changer 2104 determines that the rotational angle velocity associated with right turning or the lateral acceleration associated with second direction is being detected. The condition changer 2104 performs the second change process for the usual driving determination condition (step S209). The condition changer 2104 determines to use the right determination condition, and outputs information indicating the right determination condition to the determiner 2102 (step S210).

The condition changer 2104 determines whether the end of the duration for which the rotational angle velocity associated with right turning or the lateral acceleration associated with the second direction failing to satisfy the second criterion is detected (step S211). When determining that the end of the duration for which the rotational angle velocity associated with right turning or the lateral acceleration associated with the second direction failing to satisfy the second criterion is not detected (No in step S211), the condition changer 2104 continues the processing in step S211.

In response to detection of the end of the duration for which the rotational angle velocity associated with right turning or the lateral acceleration associated with the second direction is failing to satisfy the second criterion (Yes in step S211), the condition changer 2104 changes the determination condition from the right determination condition back to the usual driving determination condition (step S206). The condition changer 2104 performs the processing in steps S207 and S208 as described above.

With the determination condition changing operation performed by the condition changer 2104 described above, the determiner 2102 can determine whether the driver is engaging in distracted driving using various determination conditions as described below. The determiner 2102 determines whether the driver is engaging in distracted driving using the usual driving determination condition in the duration for which the rotational angle velocity or the lateral acceleration is satisfying the criterion. The determiner 2102 determines whether the driver is engaging in distracted driving using the left determination condition in the duration for which the rotational angle velocity associated with left turning or the lateral acceleration associated with the first direction is failing to satisfy the first criterion. The determiner 2102 determines whether the driver is engaging in distracted driving using the right determination condition in the duration for which the rotational angle velocity associated with right turning or the lateral acceleration associated with the second direction is failing to satisfy the second criterion.

### Support Apparatus

### Support Operation for Driver

A support operation for the driver performed by the navigation apparatus 12, which is an example of the support providing apparatus, will be described first. The navigation apparatus 12 receives an instruction signal from the distracted driving determination apparatus 2. In response to the instruction signal, the navigation apparatus 12 displays an alert for the driver about distracted driving using an image or a video on the display 121.

A support operation for the driver performed by the sound output apparatus 13, which is an example of the support providing apparatus, will now be described. The sound output apparatus 13 receives an instruction signal from the distracted driving determination apparatus 2. In response to the instruction signal, the sound output apparatus 13 outputs an alert for the driver about distracted driving using a sound from the speaker 131. An alert may be in any form that can notify the driver of his or her distracted driving or of the need to look at the front of the vehicle 1.

The driver receives the support operation from the support providing apparatus. This allows the driver to notice his or her distracted driving and refocus on driving the vehicle 1.

### 4. ADVANTAGES AND EFFECTS

In the present embodiment described above, the distracted driving determination apparatus 2 changes a determination condition defined for detecting distracted driving to a value with which distracted driving is less likely to be detected and uses the value in the duration for which the rotational angle velocity or the lateral acceleration failing to satisfy a predefined criterion is being detected, or in other words, in the duration for which the vehicle 1 is determined to be changing the traveling direction rightward or leftward than the duration for which the vehicle 1 is determined to be traveling straight.

As described below, the distracted driving determination apparatus 2 thus reduces determination in which the action of safety checking performed by the driver to the right or left is determined to be distracted driving in the duration for which the rotational angle velocity or the lateral acceleration failing to satisfy the criterion is being detected, or in other words, in the duration for which the vehicle 1 is determined to be changing the traveling direction rightward or leftward. When, for example, the driver intends to turn right, turn left, change the lane, or pull over to the side of a road, the driver is likely to direct his or her gaze or face rightward or leftward. The distracted driving determination apparatus 2 reduces determination in which the action of safety checking performed by the driver to the right or left is determined to be distracted driving in the duration for which the rotational angle velocity or the lateral acceleration failing to satisfy the criterion is being detected.

In the present embodiment, the distracted driving determination apparatus 2 further changes a determination condition defined for detecting distracted driving for the left of the vehicle 1 to a value with which distracted driving of the driver is less likely to be detected and uses the value in the duration for which the rotational angle velocity associated with left turning or the lateral acceleration associated with a first direction failing to satisfy a first criterion is being detected, or in other words, in the duration for which the vehicle 1 is determined to be changing the traveling direction leftward than when the vehicle 1 is determined to be traveling straight. The distracted driving determination apparatus 2 changes a determination condition defined for detecting distracted driving for the right of the vehicle 1 to a value with which distracted driving of the driver is less likely to be detected and uses the value in the duration for which the rotational angle velocity associated with right turning or the lateral acceleration associated with a second direction failing to satisfy a second criterion is being detected, or in other words, in the duration for which the vehicle 1 is determined to be changing the traveling direction rightward than in the duration for which the vehicle 1 is determined to be traveling straight.

As described below, the distracted driving determination apparatus 2 thus reduces determination in which the action of safety checking performed by the driver to the left of the vehicle 1 is determined to be distracted driving in the duration for which the rotational angle velocity associated with left turning or the lateral acceleration associated with the first direction failing to satisfy the first criterion is being detected, or in other words, in the duration for which the vehicle 1 is determined to be changing the traveling direction leftward. When, for example, the driver is changing the traveling direction of the vehicle 1 leftward, the driver is likely to direct his or her gaze or face to the left of the vehicle 1. The distracted driving determination apparatus 2 reduces determination in which the action of such safety checking performed by the driver to the left is determined to be distracted driving in the duration for which the rotational angle velocity associated with left turning or the lateral acceleration associated with the first direction failing to satisfy the first criterion is being detected.

The distracted driving determination apparatus 2 thus reduces determination in which the action of safety checking performed by the driver to the right of the vehicle 1 is determined to be distracted driving in the duration for which the rotational angle velocity associated with right turning or the lateral acceleration associated with the second direction failing to satisfy the second criterion is being detected, or in other words, in the duration for which the vehicle 1 is determined to be changing the traveling direction rightward. When, for example, the driver is changing the traveling direction of the vehicle 1 rightward, the driver is likely to direct his or her gaze or face to the right of the vehicle 1. The distracted driving determination apparatus 2 reduces determination in which the action of such safety checking performed by the driver to the right is determined to be distracted driving in the duration for which the rotational angle velocity associated with right turning or the lateral acceleration associated with the second direction failing to satisfy the second criterion is being detected.

In the present embodiment, the distracted driving determination apparatus 2 further performs a first change process in response to detection of a rotational angle velocity associated with the left turning or lateral acceleration associated with the first direction failing to satisfy the first criterion. The distracted driving determination apparatus 2 performs a second change process in response to detection of a rotational angle velocity associated with the right turning or lateral acceleration associated with the second direction failing to satisfy the second criterion.

As described below, the distracted driving determination apparatus 2 thus reduces, by performing the first change process, determination in which the action of safety checking performed by the driver to the left of the vehicle 1 is determined to be distracted driving in the duration for which the rotational angle velocity associated with left turning or the lateral acceleration associated with the first direction failing to satisfy the first criterion is being detected.

When, for example, the driver is changing the traveling direction of the vehicle 1 leftward, the driver is likely to direct his or her gaze or face to the left of the vehicle 1. The distracted driving determination apparatus 2 reduces determination in which the action of such safety checking performed by the driver to the left is determined to be distracted driving in the duration for which the rotational angle velocity associated with left turning or the lateral acceleration associated with the first direction failing to satisfy the first criterion is being detected.

As described below, the distracted driving determination apparatus 2 reduces, by performing the second change process, determination in which the action of safety checking performed by the driver to the right of the vehicle 1 is determined to be distracted driving in the duration for which the rotational angle velocity associated with right turning or the lateral acceleration associated with the second direction failing to satisfy the second criterion is being detected.

When, for example, the driver is changing the traveling direction of the vehicle 1 rightward, the driver is likely to direct his or her gaze or face to the right of the vehicle 1. The distracted driving determination apparatus 2 reduces determination in which the action of such safety checking performed by the driver to the right is determined to be distracted driving in the duration for which the rotational angle velocity associated with right turning or the lateral acceleration associated with the second direction failing to satisfy the second criterion is being detected.

### 5. MODIFICATIONS

The present invention is not limited to the present embodiment, but the components may be modified without departing from the spirit and scope of the invention. The components described in the present embodiment may be combined as appropriate to provide various aspects of the invention. For example, some of the components described in the present embodiment may be eliminated. Further, components in different embodiments may be combined as appropriate.

### 6. APPENDIX

The present embodiment may be partially or entirely expressed in, but not limited to, the following forms shown in the appendix below in addition to the claims.

### Appendix 1

A distracted driving determination apparatus mounted on a vehicle and comprising a hardware processor, the hardware processor being configured to

obtain a first detection information indicating a gaze or a face orientation of a driver;

determine whether the driver is engaging in distracted driving based on the gaze or the face orientation of the driver indicated by the first detection information and a first determination condition defined for detecting distracted driving;

obtain second detection information indicating a rotational angle velocity about a vertical axis or lateral acceleration of a vehicle; and

change the first determination condition to a second determination condition different from the first determination condition to use the second determination condition in a duration for which the rotational angle velocity or the lateral acceleration failing to satisfy a predefined criterion is being detected based on the second detection information.

### Appendix 2

A distracted driving determination method performed by a distracted driving determination apparatus mounted on a vehicle, the method comprising:

obtaining, with at least one hardware processor, a first detection information indicating a gaze or a face orientation of a driver;

determining, with at least one hardware processor, whether the driver is engaging in distracted driving based on the gaze or the face orientation of the driver indicated by the first detection information and a first determination condition defined for detecting distracted driving;

obtaining, with at least one hardware processor, second detection information indicating a rotational angle velocity about a vertical axis or lateral acceleration of a vehicle; and

changing, with at least one hardware processor, the first determination condition to a second determination condition different from the first determination condition to use the second determination condition in a duration for which the rotational angle velocity or the lateral acceleration failing to satisfy a predefined criterion is being detected based on the second detection information.

1. A distracted driving determination apparatus, comprising:
a first obtaining unit configured to obtain first detection information indicating a gaze or a face orientation of a driver;
a determiner configured to determine whether the driver is engaging in distracted driving based on the gaze or the face orientation of the driver indicated by the first detection information and a first determination condition defined for detecting distracted driving;
a second obtaining unit configured to obtain second detection information indicating a rotational angle velocity about a vertical axis or lateral acceleration of a vehicle; and
a condition changer configured to change the first determination condition to a second determination condition different from the first determination condition to use the second determination condition in a duration for which the rotational angle velocity or the lateral acceleration failing to satisfy a predefined criterion is being detected based on the second detection information.

2. The distracted driving determination apparatus according to claim 1, wherein
the condition changer changes a left determination condition included in the first determination condition and defined for detecting distracted driving for a left of the vehicle to a left determination condition included in the second determination condition to use the left determination condition in a duration for which the rotational angle velocity associated with left turning of the vehicle or the lateral acceleration associated with a first direction from left to right of the vehicle failing to satisfy a predefined first criterion is being detected,
and changes a right determination condition included in the first determination condition and defined for detecting distracted driving for a right of the vehicle to a right determination condition included in the second determination condition to use the right determination condition in a duration for which the rotational angle velocity associated with right turning of the vehicle or the lateral acceleration associated with a second direction from right to left of the vehicle failing to satisfy a predefined second criterion is being detected.

3. The distracted driving determination apparatus according to claim 1, wherein
the condition changer changes the first determination condition to the second determination condition to enlarge an area in which the gaze or the face orientation of the driver is allowed to reside without detection of distracted driving.

4. The distracted driving determination apparatus according to claim 1, wherein
the determiner determines that the driver is not engaging in distracted driving when the gaze or the face orientation of the driver is within a first area defined in front of the driver, and
determines that the driver is engaging in distracted driving when the gaze or the face orientation of the driver resides within a second area defined on the left of the vehicle and adjacent to the first area for longer than a first duration, or within a third area defined on the right of the vehicle and adjacent to the first area for longer than a second duration.

5. The distracted driving determination apparatus according to claim 4, wherein
the condition changer performs, in response to detection of the rotational angle velocity associated with left turning or the lateral acceleration associated with the first direction failing to satisfy the first criterion, a first change process at least by shifting a boundary between the first and second areas from a position used when the rotational angle velocity or the lateral acceleration satisfies the criterion to a position to enlarge the first area, or by extending the first duration,
and performs, in response to detection of the rotational angle velocity associated with right turning or the lateral acceleration associated with the second direction failing to satisfy the second criterion, a second change process at least by shifting a boundary between the first and third areas from a position used when the rotational angle velocity or the lateral acceleration satisfies the criterion to a position to enlarge the first area, or by extending the second duration.

6. The distracted driving determination apparatus according to claim 1, further comprising:
an output unit configured to output an instruction signal to a support apparatus to support the driver when the determiner determines that the driver is engaging in distracted driving.

7. A distracted driving determination method performed by a distracted driving determination apparatus mounted on a vehicle, the method comprising:
obtaining, with the distracted driving determination apparatus, a first detection information indicating a gaze or a face orientation of a driver;
determining, with the distracted driving determination apparatus, whether the driver is engaging in distracted driving based on the gaze or the face orientation of the driver indicated by the first detection information and a first determination condition defined for detecting distracted driving;
obtaining, with the distracted driving determination apparatus, second detection information indicating a rotational angle velocity about a vertical axis or lateral acceleration of a vehicle; and
changing, with the distracted driving determination apparatus, the first determination condition to a second determination condition different from the first determination condition to use the second determination condition in the duration for which the rotational angle velocity or the lateral acceleration failing to satisfy a predefined criterion is being detected based on the second detection information.

8. A non-transitory computer-readable medium storing a program for determining distracted driving, the program causing a computer to implement processes performed by the units included in the distracted driving determination apparatus according to claim 1.
